(19) United States
(12) Patent Application Publication
(10) Pub. No.: US 2025/0010207 A1
(43) Pub. Date: Jan. 9, 2025

(54) METHOD FOR CHURN DETECTION IN A SIMULATION

(71) Applicant: Sony Interactive Entertainment Inc.

(72) Inventors: Chen Yao, Bloomingdale, IL (US); Nobuyuki Nakamura, Yokohama (JP); Sagnik Chowdhury, San Jose, CA (US); Ratnakar Pawar, Redwood City, CA (US); Robert Brown, Lafayette, CA (US); Jun Murakawa, Redwood City, CA (US)

(21) Appl. No.: 18/219,607

(22) Filed: Jul. 7, 2023

(51) Int. Cl. A63F 13/798; A63F 13/67; G06N 3/04; G06N 3/08

(52) U.S. Cl. CPC A63F 13/798; A63F 13/67; G06N 3/04; G06N 3/08

(57) ABSTRACT

Aspects of the present disclosure relate to detecting churn in video games. Gameplay data for a video game is collected. The collected data is then analyzed with a first trained neural network to identify a pattern associated with one or more patterns associated with a player stopping playing the video game. The one or more patterns are analyzed with a second trained neural network to associate the one or more identified patterns with one or more reasons for the player stopping playing the video game. The one or more reasons are presented to a game developer. A system for detecting player churn in video games and methods for training such a system are also disclosed.

### FIELD OF THE DISCLOSURE

The present disclosure relates generally to computer-simulated video games, and more specifically to detecting player chum in video games.

### BACKGROUND OF THE DISCLOSURE

It is important for game publishers that players remain engaged with their products. Players leave games for different reasons, including game complexity, game defects, toxic game community, frustration, and boredom. Chum refers to the frequency with which players stop playing a game. It is important for a gaming platform to be able to detect chum, model it and turn it over to publishers so that they can retain players.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a schematic diagram of a system for churn detection in video games according to an aspect of the present disclosure.

FIG. 2 is a flow diagram of a method for chum detection in video games according to an aspect of the present disclosure.

FIG. 3 is a diagram showing an example of a system for inferring structured context information from different sources of unstructured data according to aspects of the present disclosure.

FIG. 4 is a diagram depicting an example of recognition of input events using correlation of unlabeled inputs with an inference engine according to aspects of the present disclosure.

FIG. 5 is a diagram depicting an example layout of modal modules in a multi-modal recognition network of an inference engine according to aspects of the present disclosure.

FIG. 6A is a simplified node diagram of a recurrent neural network according to aspects of the present disclosure.

FIG. 6B is a simplified node diagram of an unfolded recurrent neural network according to aspects of the present disclosure.

FIG. 6C is a simplified diagram of a convolutional neural network according to aspects of the present disclosure.

FIG. 6D is a block diagram of a method for training a neural network that is part of churn detection in video games according to aspects of the present disclosure.

FIG. 6E is a flow diagram of a method for training a neural-network to implement a method for location-based player feedback for video games according to an aspect of the present disclosure.

FIG. 7 illustrates an example of a deep learning neural network used for detecting chum according to an aspect of the present disclosure.

FIG. 8 is a block diagram of a computer system for detecting churn according to an aspect of the present disclosure.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the disclosure. Accordingly, examples of embodiments described below are set forth without any loss of generality to, and without imposing limitations upon, the present disclosure.

According to aspects of the present disclosure, one or more artificial intelligence (AI) agents can analyze gameplay data to surface the relevant reasons that players leave a game or stop using an application to address churn in video games and other applications. The AI agents can analyze data at all levels from controller input level to game context level to player community level. Some AI agents may be used to determine if a player has quit. Other AI agents may be used to determine why a player has quit. In addition, aspects of the present disclosure include use of AI agents to determine how to address the reasons a player has quit.

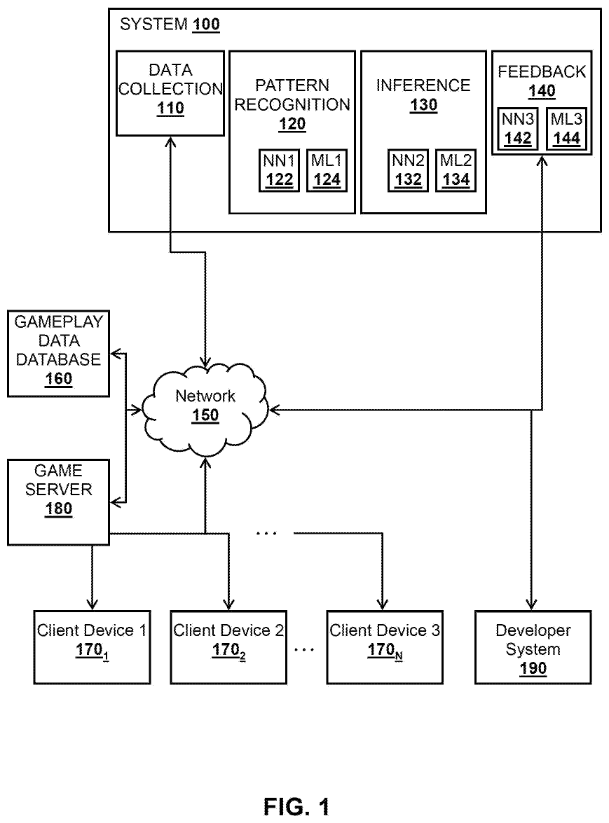

The block diagram shown in FIG. 1 depicts a non-limiting example of an implementation of a location-based player feedback system 100, according to some aspects of the present disclosure. In implementation depicted, the system 100 includes a data collection module 110 operable to collect gameplay data for a video game, a pattern recognition module 120 operable to analyze the collected gameplay data to identify a pattern associated with a player stopping playing the video game, an inference module 130 operable to associate a reason for the player leaving the video game with the identified pattern, and a feedback module 140 operable to present a game developer with the one or more reasons for the player stopping playing the video game. In some implementations, the feedback module could rank the reasons in order of likelihood.

Components of the system 100 may be operable to communicate with other devices over a Network 150, e.g., through a suitably configured network interface. For example, the data collection module 110 may retrieve gameplay data over the network 150 from a remote gameplay data database 160. The gameplay data database 160 may, in turn, collect gameplay date from an arbitrary number N of client devices 170₁, 170₂, 170₃ . . . 170_{N}, which may be gaming consoles, portable gaming devices, desktop computers, laptop computers or mobile devices, such as tablet computers or cell phones that are operable to allow players to play the game. The gameplay database 160 may additionally receive gameplay data from a game server 180 that is operable to perform computations and other functions that allow the players to play the game via the client devices 170₁, 170₂ . . . 170_{N}. Furthermore, the system 100 may communication with a developer system 190 that is run by an individual or organization that develops video games, specifically including one or more video games for which the system 100 detects chum.

In some implementations, the pattern recognition module 120 may include one or more pattern detection neural networks 122 trained to detect patterns in gameplay data that may be associated with players stopping playing video games. The pattern detection neural networks 122 may be trained with one or more suitably configured pattern recognition machine learning algorithms 124. In some implementations, the inference module 130 may include inferencing neural networks 132 trained to associate reasons for the player leaving the video game with patterns of gameplay data. The inferencing neural networks 132 may be trained with one or more suitably configured machine learning algorithms 134. By way of non-limiting example, one or more of the inferencing neural networks 132 may be trained to identify game world locations from patterns of gameplay data identified by the one or more of pattern recognition neural networks 122.

In some implementations, the feedback module 140 may include one or more trained networks 142 trained with one or more suitably configured machine learning algorithms 144. By way of example, these may include a neural network trained to rank two or more reasons for a player stopping playing the game. Reasons may be ranked in terms of importance or relevance to the player stopping playing the game. Alternatively, reasons may be ranked in terms of a degree of control the game developer has over them. For example, a game developer has more control over player churn resulting from the mechanics of a game than over churn due to external factors, such as seasonality or player demographics.

There are a number of ways that the system 100 may operate to detect player churn. For example, in some implementation, the data collection module 110 may be operable to collect player text or audio chat data. In some such implementations, one or more of the pattern recognition neural networks 122 in the pattern recognition module 120 may be trained to detect patterns in player chat data that are associated with player difficulty with one or more video games. In some such implementations, the pattern recognition module 120 may include one or more pattern recognition neural networks trained to detect patterns in player chat data that are associated with player difficulty with another player of one or more video games.

The system may operate on other types of gameplay data as well. For example, in some implementations, the data collection module 110 may be operable to collect controller input data for one or more video game peripheral devices. In some such implementations, the data collection module may collect peripheral input data for one or more video game controllers and the pattern recognition module 120 may be operable to identify one or more patterns in the peripheral input data associated with a player stopping playing the video game. By way of example, and not by way of limitation, the peripheral input data may include inputs to one or more video game controllers and/or inertial measurement unit (IMU) data for one or more IMU associated with one or more video game controllers and/or one or more microphones.

In some implementations, the feedback module 140 may be further operable to analyze the one or more reasons for the player stopping playing the video game and to generate a different gameplay experience for the video game than for other players of the video game and present the different experience to a subset of players of the video game. The feedback module may use the reason(s) for the player stopping playing to generate or recommend a different gameplay experience. For example, the inference module 130 may have inferred from identified patterns that players tend to quit a game in frustration after reaching a certain level of the game or after reaching a certain location in a game level. The feedback module 140 may generate or recommend a different game experience in the form of a modified version of the game that omits the level or location in question. In some implementations, the developer system 190 may generate the different game experience and roll it out to selected players. A correspondingly modified version of the game may then be presented to some subset of the players in the game. In some implementations, the feedback module 140 may be operable to determine a difference in player retention between players that were presented with the different gameplay experience and players that were not presented the different gameplay experience.

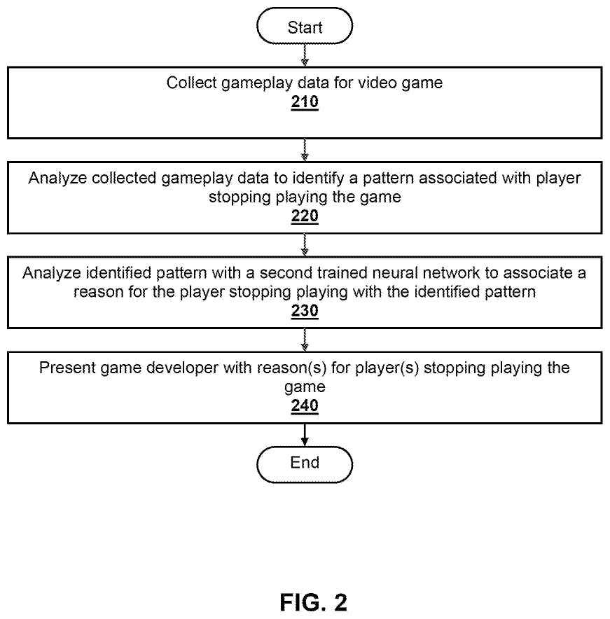

FIG. 2 is a flow diagram that describes a method for churn detection in video games according to some aspects of the present disclosure. In some implementations, the method may include collecting gameplay data for a video game, as indicated at 210. There are a number of types of gameplay data that may be collected. The nature of collection depends partly on the source of the data. Some data, such as controller inputs, may be collected directly from a player's gaming console or portable gaming device. In online gaming implementations, some data may be collected from the game server 180 that implements certain computations based on a player's controller inputs and transmits video data back to the player's device. Still other data may be collected from a data service associated with the game server. Other data may be collected from social media services that are associated with the game server or with the player. The collection module 110 may collect gameplay data over some predetermined window of time. The window of time may be long enough to collect enough data to be useful to the pattern recognition module 120. In some implementations, structured gameplay data that may be relevant to difficulty with a game world location may be provided by a game engine running on one or more of the client devices 170₁, 170₂ . . . 170_{N} or on the game server 180. Such structured data may include, e.g., the game title, current game level, current game task, time spent on current task or current level, number of previous attempts at current task by the player, current game world locations for player and non-player characters, game objects in a player character's inventory, player ranking, and the like.

There are a number of different types of data that may be collected. Some non-limiting examples include current game level, current game activity, player character load out (e.g., weapons or equipment), player rank, time spent on a game session, time spent in a particular region or level of a game world, and number of times a player has failed at a particular task, just to name a few.

In some implementations, the data collection module 110 may collect video game telemetry data. Game telemetry data can provide insight in to what activity player is doing, what equipment or weapons a player character can access, the player's game world location, the amount of time within a game world region, or how many times players failed an activity, among other things. As used herein, video game telemetry data refers to the information collected by games through various sensors, trackers, and other tools to monitor player behavior, game performance, and other relevant metrics. Some examples of video game telemetry data include (1) player activity, such as data on how long players spend on specific levels or missions, the frequency of their logins, the amount of time spent in the game, and how often they return to the game, (2) in-game actions performed by players, such as the number of kills or deaths in a first-person shooter game, or the number of goals scored in a soccer game, (3) game performance including data on how the game performs, such as the frame rate, latency, and other technical metrics that can impact the player experience, (4) player engagement, such as the number of times they use specific features or interact with certain game elements, (5) error reports generated by the game or experienced by players, (6) platform information, such as device type, and operating system, (7) user demographic information, such as age, gender, location, and other relevant data, (8) social features, such as how player interact each other with in-game chat and friend invites, (9) in-game economy, such as tracking patterns of purchases and/or sales of virtual items, and (10) progression, such as tracking player achievements and/or trophies and/or pace of progress.

In some implementations, certain useful gameplay context information might not be directly available but might be derivable from unstructured data that is more readily collected. In such implementations, the collection module 110 in the system 100 may collect unstructured gameplay data, such as video image data, game audio data, controller input data, group chat data, and the like. It may be useful to provide structure to such data to facilitate processing by the pattern recognition module 120, inference module 130, and feedback module 140. Furthermore, the collection module 110 may collect different modes of data, such as video data, audio data, along with structured data.

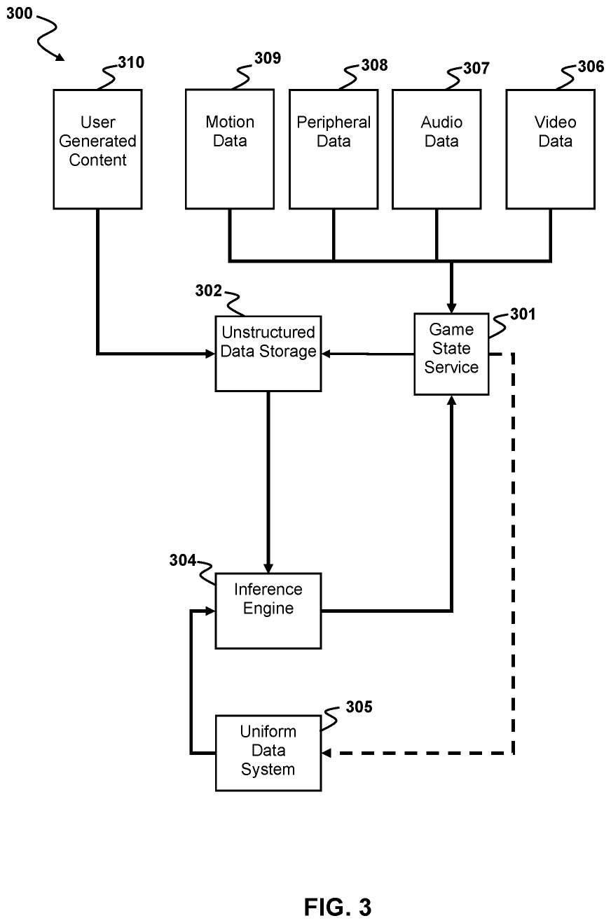

FIG. 3 is a diagram showing an example of data collection system architecture 300 for a player churn detection system that can collect multi-modal gameplay data. In the implementation shown the system 300 may execute an application that does not expose the application data structure to a uniform data system (UDS) 305, which may include the gameplay database 160. Instead, the inputs to the application such as peripheral input 308 and motion input 309 are interrogated by a game state service 301 and sent to unstructured data storage 302. The game state service 301 also interrogates unstructured application outputs such as video data 306 and audio data 307 and stores the data with unstructured data storage 302. Additionally, user generated content (UGC) 310 may be used as inputs and provided to the unstructured data storage 302. The game state service 301 may collect raw video data from the application which has not entered the rendering pipeline of the device. Additionally, the game state service 301 may also have access to stages of the rendering pipeline and as such may be able to pull game buffer or frame buffer data from different rendered layers which may allow for additional data filtering. Similarly raw audio data may be intercepted before it is converted to an analog signal for an output device or filtered by the device audio system.

The inference engine 304 receives unstructured data from the unstructured data storage 302 and predicts context information from the unstructured data. The context information predicted by the inference engine 304 may be formatted in the data model of the uniform data system. The inference engine 304 may also provide context data for the game state service 301 which may use the context data to pre-categorize data from the inputs based on the predicted context data. In some implementations, the game state service 301 may provide game context updates at update points or at game context update interval to the UDS 305. These game context updates may be provided by the UDS 305 to the inference engine 304 and used as base data points that are updated by context data generated by the inference engine. The context information may then be provided to the UDS 305. The UDS 305 may also provide structured information to the inference engine 304 to aid in the generation of context data.

The inference engine 304 may receive unstructured data from the unstructured data storage 302 and predict context information from the unstructured data. The context information predicted by the inference engine 304 may be formatted in the data model of the uniform data system. The inference engine 304 may also provide context data for the game state service 301 which may use the context data to pre-categorize data from the inputs based on the predicted context data. The information from the inference engine 304 can be used to store useful information, such as whether an audio clip includes a theme song or a current image is a daytime image). This stored information can then be used by a game state service 301 to categorize new data, e.g., in the form of a lookup or closeness similarity. For example, if the inference engine finds that a piece of audio data is a theme song the game state service 301 could simply provide this piece with the contextual label whenever it appears in the unstructured data. In some implementations, the game state service 301 may provide game context updates at update points or at game context update interval to the UDS 305. These game context updates may be provided by the UDS 305 to the inference engine 304 and used as base data points that are updated by context data generated by the inference engine. In some implementations the inference engine 304 may include optical character recognition components which may convert text from the screen that is not machine readable to machine readable form. The inference engine may then analyze the resulting machine-readable text using a suitably configured text analysis neural network to extract relevant context information. Furthermore, the inference engine may include an object recognition component, e.g., a neural network trained to recognize specific objects that are relevant to context. Such objects may include characters, locations, vehicles, and structures.

The context information may then be provided to the UDS 305. As discussed above the UDS may be used to provide additional services to the user. The UDS 305 may also provide structured information to the inference engine 304 to aid in the generation of context data.

By way of example, the peripheral input 308 may include a sequence of button presses. Each button press may have a unique value which differentiates each of the buttons. The inference engine may include a neural network trained to recognize certain specific sequences of button presses as corresponding to a specific command. While the above discusses button presses it should be understood that aspects of the present disclosure are not so limited and the button presses recognized by the sequence recognition module may include joystick movement directions, motion control movements, touch screen inputs, touch pad inputs and similar.

By way of example, the motional control input 309 may include inputs from one or more inertial measurement units (IMUs). By way of example, the IMUs may include one or more accelerometers and/or gyroscopes located in a game controller or 6 or HMD 102. In such implementations the inference engine 304 may include one or more neural networks operable to classify unlabeled motion inputs from the IMU. The motion control neural networks may be trained to differentiate between motion inputs from the HUD, the game controller and other motion devices or alternatively a separate motion control classification module may be used for each motion input device (e.g., controller, left VR foot controller, right VR foot controller, left VR hand controller, right VR hand controller, HMD etc.) in the system. The output of the IMUs may be a time series of accelerations and angular velocities which may be processed to correspond to movements of the controller or HMD with respect to X, Y, and Z axes. The motion control classification neural networks in the inference engine 304 may be trained to classify changes in angular velocity of the HMD as simple movements such as looking left or right.

In some implementations, it may be desirable to reduce the dimensionality of the gameplay data collected by the collection module 110. Data dimensionality may be reduced through the use of feature vectors. As used herein, a feature vector refers to a mathematical representation of a set of features or attributes that describe a data point. It can be used to reduce the dimensionality of data by converting a set of complex high-dimensional data into a smaller, more manageable set of features that capture the most important information.

To create a feature vector, a set of features or attributes that describe a data point are selected and quantified. These features may include numerical values, categorical labels, or binary indicators. Once the features have been quantified, they may be combined into a vector or matrix, where each row represents a single data point and each column represents a specific feature.

The dimensionality of the feature vector can be reduced by selecting a subset of relevant features and discarding the rest. This can be done using a variety of techniques, including principal component analysis (PCA), linear discriminant analysis (LDA), or feature selection algorithms. PCA, for example, is a technique that identifies the features of interest in a dataset and projects the data onto a lower-dimensional space. This is done by finding the directions in which the data varies the most, and then projecting the data onto those directions. The resulting feature vector has fewer dimensions than the original data, but still captures relevant information. As an example, consider a dataset corresponding to images of different objects, where each image is represented by a matrix of pixel values. Each pixel value in the matrix represents the intensity of the color at that location in the image. Treating each pixel value as a separate feature produces in a very high-dimensional dataset, which can make it difficult for machine learning algorithms to classify or cluster the images. To reduce the dimensionality of the data, the system 100, e.g., data collection module 110 and/or pattern recognition module 120 and/or inference module 130 may create feature vectors that summarizes the relevant information in each image, e.g., by calculating the average intensity of the pixels in the image, or extracting features that capture the edges or shapes of the objects in the image. Once a feature vector is created for each image, these vectors can be used to represent the images in a lower-dimensional space, e.g., by using principal component analysis (PCA) or another dimensionality reduction technique to project the feature vectors onto a smaller number of dimensions.

Referring again to FIG. 2, at 220, the collected gameplay data may then be analyzed, e.g., with one or more of the trained pattern recognition neural networks 122, to identify one or more patterns in the gameplay data associated with a player stopping playing the video game. Such patterns may include a pattern of change in the frequency of gameplay sessions of a given game for a given player over time. A decrease in gameplay frequency may indicate a loss of interest in the given game, particularly if the player continues to play other games. Other patterns that might be relevant to a player stopping playing may include patterns of comments made in in-game chat or comments made on social media related to the game. A pattern of comments by a player that mention the game followed by an extended period in which the player does not comment on the game might indicate that the player has lost interest in the game. In some implementations, data collection at 210 and analysis at 220 may be iteratively repeated to verify that churn is in fact happening.

As noted above, one or more of the pattern recognition neural networks 122 may be trained to detect patterns in gameplay data that are associated with player difficulty or boredom with one or more video games. Such patterns may provide a clue to why a player may have quit playing a game. There are a number of different gameplay data patterns that such neural network may be trained to detect. By way of non-limiting examples, one or more of the pattern recognition neural networks may be trained to detect (1) repeated unsuccessful attempts to complete a game level, repeated unsuccessful attempts to complete a game tasks within a game level, (3) erratic, aberrant or unusual patterns of controller input indicative of frustration, e.g., multiple repeated button presses after failure to complete a task, inertial sensor input consistent with the player throwing the controller, (4) player speech, e.g., detected with a microphone on a game console, gaming headset, or controller, that is indicative of frustration, (5) text or voice chat language indicative of frustration, (6) player facial expression or body language indicative of frustration, e.g., determined from analysis of images of the player obtained with a video camera trained on the player, (7) user generated content (UGC) expressing frustration with a game, and (8) patterns of player input and game output likely to cause frustration. As an example of pattern (8), consider a situation in which the movement of a player-controlled game character is inconsistent with the player's controller inputs.

In some implementations, one or more of the neural networks 122 in the pattern recognition module 120 may be trained to detect patterns in game telemetry data that may suggest player frustration, either on their own or in combination with other patterns. Examples of such patterns may include (1) patterns of players spending too much or too little time on specific levels or missions, changes in the frequency of their logins or the amount of time spent in the game, (2) patterns of inactivity during a game session, (3) patterns in game performance including frame rate or latency, (4) patterns of player engagement, such use of specific game features or interaction with certain game elements, (5) patterns in error reports generated by the game or reported by players, (6) patterns in platform information, such as device type, and operating system, and (7) user demographic information, such as age, gender, location, and other relevant data.

It is further noted that the pattern recognition module 120 may be operable to detect combinations of two or more types of patterns. Detecting multiple patterns may improve the likelihood of detecting actual player frustration and decrease the likelihood of false positives.

Once one or more patterns have been recognized, the pattern recognition module may provide the inference module 130 with a set of relevant gameplay data and/or game telemetry data corresponding to the detected pattern or patterns. Such relevant gameplay data may include structured data, such as game title, game level, game world location (if provided by the game engine), transcripts of relevant player speech, chat, or UGC, game screen images or video, game audio, controller inputs, relevant game telemetry data. The relevant data may correspond to a subset of the gameplay data collected by the collection module 110 and/or data corresponding to patterns recognized by one or more of the pattern recognition neural networks 122 from analysis of that data. Such patterns may include structured data derived from unstructured data. The relevant data may relate to what the player is doing and where the player has been within the game world during the window of time over which the collection module 110 has collected gameplay data. The relevant data may also include metadata that, e.g., identifies the nature of a pattern, e.g., “too many failures” at this level, “high latency”, “erratic controller input”, taking an abnormally high time to progress in the game, a significant downward trend in playing frequency and time, negative user behaviors, inventory reduction and the like.

At 230, the method may include analyzing the identified patterns with a second trained neural network to associate a game world location with the identified pattern. By way of example, and not by way of limitation, one or more of the inferencing neural networks 132 may analyze the relevant data provided by the pattern recognition module 120 to determine whether or not the pattern has any relation to a reason that a play might stop playing a game. This may be done by determining, e.g., if the pattern has appeared in association with other players having stopped playing the game. The inferencing machine learning models do not necessarily need to be trained with labeled data. Some neural networks can infer reasons from inputs, e.g., gameplay patterns, alone. In some implementations, for example, a pattern identified by the pattern recognition module 120 may be presented without labels to the inferencing module 130, which may explore the pattern and infer reasons for a player stopping playing.

One or more of the inferencing neural networks 132 may operate on the patterns identified by the pattern detection neural networks to classify one or more reasons a player might quit playing a game. Furthermore, the inferencing module 130 may analyze the patterns identified by the pattern recognition module to correlate different reasons why the player stopped playing the game. By way of example, the inferencing machine learning algorithms 134 may include one or more unsupervised learning models operable to find patterns, structures, or relationships within the data patterns identified by the pattern recognition module without the need for explicit labels or targets.

By way of example, the inferencing machine learning algorithms 134 may include one or more autoencoders. An autoencoder consists of an encoder and a decoder network. The encoder compresses the input data into a lower-dimensional representation called the latent space, while the decoder tries to reconstruct the original input from the compressed representation. By training the autoencoder on unlabeled data, it learns to capture the underlying structure or features of the data. The encoder part of the autoencoder can be used to infer reasons or explanations for the given patterns in the data.

Another unsupervised learning model that can be used is a clustering algorithm, such as k-means or Gaussian mixture models. Clustering algorithms group similar data points together based on their features or distance metrics. Applying clustering to unlabeled data can reveal natural groupings or patterns within the data that can provide insights into potential reasons or explanations for the observed patterns.

As an example of correlating multiple factors consider a situation in which the pattern recognition module determines that a player has not played a game for several months after having played it frequently and also detects patterns in the player's gameplay data that area consistent with frustration with the game and also a seasonal pattern of other players tending to quit the game at about the same time. The inferencing module 130 may analyze these patterns. Examples of patterns consistent with player frustration may include, but are not limited to (1) IMU controller data patterns consistent with the player having thrown the controller, (2) microphone inputs of the player expressing general frustration (e.g., cursing or growling) or specific frustration (statements like “I hate this game!”), (3) player sentiment on chat, and (4) game world location.

With respect to (3), player sentiment may include historical sentiment, e.g., a pattern of statements expressing a particular sentiment over time. Player sentiment may refer to the player's sentiment with respect to a game or with respect to another player. With respect to (4), some game world locations may be particularly difficult or challenging for some players. Game world location may be relevant, e.g., if the player's session ends while the player is in a particular game world location. For example, in a loot-based game, a pattern of a player character repeatedly falling into the same trap could be associated with the location of the trap. As another example, in a racing game, a pattern of a player character repeatedly crashing on the same curve on a given racetrack could be associated with the location of the curve on the racetrack. A further example may be a pattern of players taking too long to solve particular puzzle in an adventure game, making repeated attempts, or quitting in the game in the area could be associated with the location of the puzzle in the game world. An additional example may be a pattern of many players losing in combat against a specific enemy or boss character and a change in player engagement could be associated with the location of the challenging enemy encounter in the game world.

In addition, the pattern recognition module 120 and/or inferencing module 130 may look to communications on social media between the player and others. A player's friends may often provide reasons for a player to stop playing a game, such as game or achievement completion.

Once one or more reasons for a player stopping the game have been identified, feedback module 140 present a game developer with a report containing one or more reasons for one or more players stopping playing the game, as indicated at 240 of FIG. 2. In addition, the feedback module may recommend or perform experiments to determine player retention/experience. For example, in some implementations, the feedback module 140 may be further operable to analyze the one or more reasons for the player stopping playing the game and generate a different gameplay experience for the video game and present the different experience to a subset of players of the video game. In such implementations, the feedback module may further operate to determine a difference in player retention between players that were presented with the different gameplay experience and players that were not presented the different gameplay experience. As an example, suppose the inferencing module determines that players tend to leave a racing game and not return after multiple crashes on a particular curve in a particular racetrack in the game. The feedback module may present some new players, but not all, with a different curve on the racetrack. The system 100 may monitor the new players to determine if the players presented with the different curve have a better rate of retention than players who were not so presented.

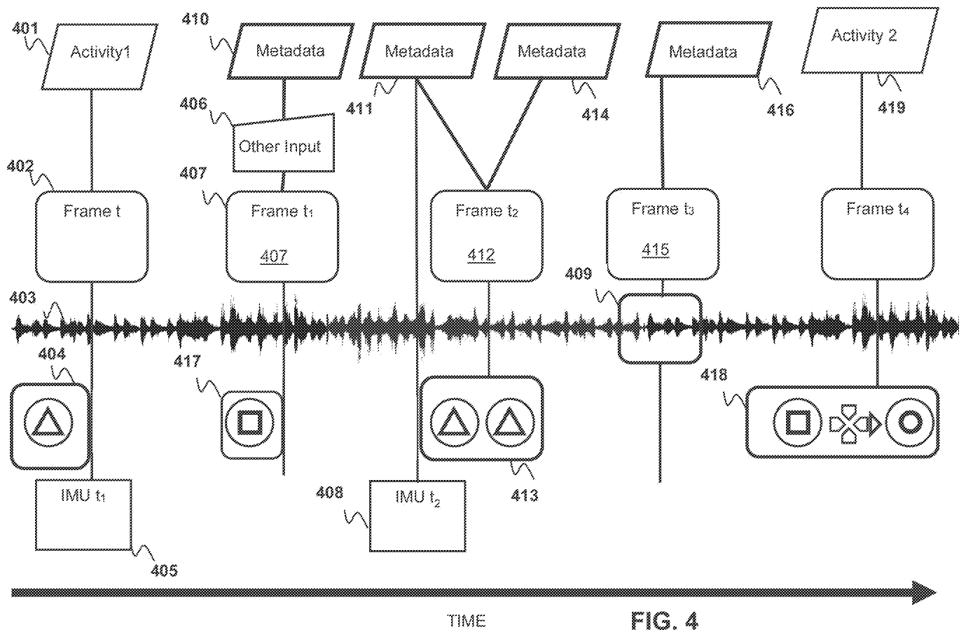

As noted above, it is often useful to be able to derive gameplay context information that is not readily available from readily available input events. Doing so may involve correlation of different types of input events. FIG. 4 is a diagram depicting an example of recognition of input events using correlation of unlabeled inputs with an inference engine when deriving gameplay context information useful to detect video game play churn according to aspects of the present disclosure. In some implementations multimodal data processing may be used to further confirm predictions made by an inference engine, such as inference engine 304 of FIG. 3. This can reduce processing time if a prediction in one data modality results in avoiding additional processing.

As shown in FIG. 4, the inference engine may receive inputs from multiple modalities, including video/image frames 402, audio data 403, peripheral (e.g., game controller or HMD) inputs 404, and motion data 405. The system may generate context information that includes activities 401 and metadata 410. The multi-modal fusion of different types of inputs allows for the discovery of correlated inputs which may provide enhanced functionality and a reduction in processing because less processing intensive indicators of events may be discovered. For example, and without limitation, during training the system may be operable to recognize that a certain sound indicates 409 that player has fired an arrow as such the screen data 415 for the ammo count no longer needs to be processed because the system can wait for the sound and keep a count of the number of arrows shot. In another example shown the system may identify motion data 408 indicating player motion and, as such, an image frame 412 on the screen does not need to be examined to determine the direction a player in a game is facing. In addition, the system may implement an ensemble model that can perform say the arrow count through both audio analysis as discussed above and image analysis to strengthen the arrow count prediction.

In some implementations the inference engine may generate an internal game state representation that is updated with UDS data each time the multi-modal neural networks generated a classification. The inference engine may also use peripheral input to correlate game state changes for example a series of triangle button presses 413 may be identified as corresponding to performing a dash attack. As such, image frames 412 do not need to be classified to determine the activation of a dash attack and if the dash attack has a movement component player location does not need to be determined. Instead, the inference engine may simply update the context information with information corresponding to the dash attack. In another example, other input information 406 may be used to determine game context information for example and without limitation the user may save a screenshot and upload it to social media, the inference engine may correlate this to pausing the game and the inference engine may not have to classify peripheral inputs 417 or image frames 407 of the game screen to determine that the game is paused and update the game context. Finally, the inference engine may identify certain peripheral input sequences 418 that correspond to certain menu actions and update the activities 419 based on the internal game state representation. For example, and without limitation, the trained inference engine may determine that the peripheral input sequence 418 circle, right arrow, square, corresponds to opening up a quest menu and selecting the next quest in a quest list. Thus, the activity 419 may be updated by simply changing an internal representation of the game state to the next quest based on the identified input sequence. These are just some examples of the time coincident correlations that may be discovered and use of indirect prediction of game context by the inference engine.

Additionally, the inference engine may retain an internal game state and update the internal game state with each received and classified input. In some implementations the inference engine may receive game state updates from the UDS periodically or at an update interval. These game state updates may be generated by the game and sent periodically or at an interval to the UDS. The game state updates may be used by the inference engine to build the internal game state and update the internal game state. For example, at the start of an Activity 401 the activity data may be provided by the game to the UDS with initial meta-data for the game state. While playing the game may not provide updates to the UDS and the inference engine may update the game state with metadata 410, 411, 414, 416 until the next game state update. The game state updates at activities 401, 419 may reduce the amount of processing required because it may contain information that the inference engine can use to selectively disable modules. For example, the game context update may provide metadata that indicate that the game takes place in the Old West and does not contain any motorized vehicles as such modules trained for recognition of certain motorized vehicle sounds or motorized vehicle objects may be turned off. This saves processing power as the image and sound data does not need to be analyzed by those modules.

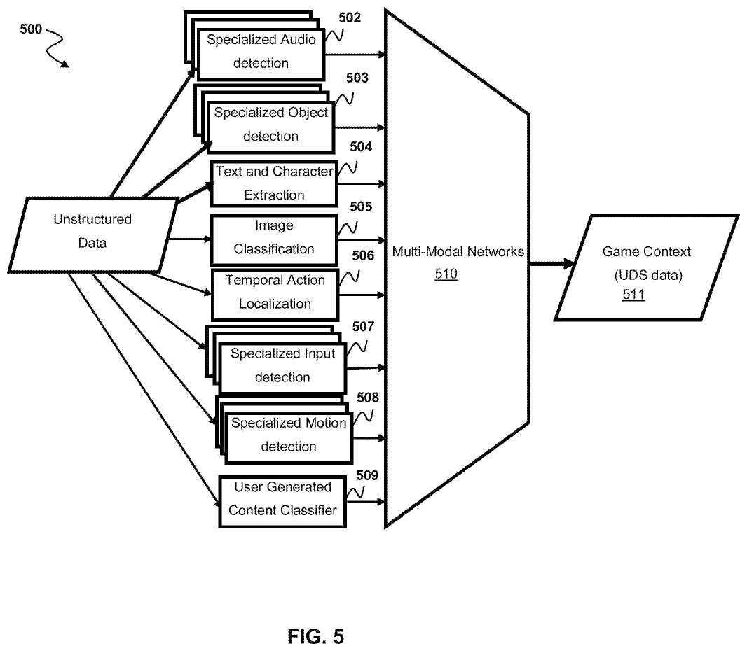

FIG. 5 is a diagram depicting an example layout of unimodal modules in a multi-modal recognition network of the inference engine according to aspects of the present disclosure. As shown the inference engine includes one or more unimodal modules operating on different modalities of input information and a multi-modal module which receives information from the unimodal modules. In the implementation shown the inference engine 500 includes the unimodal modules of; one or more audio detection modules 502, one or more object detection modules 503, a text and character extraction module 504, an image classification module 505, temporal action localization module 506, one or more input detection modules 507, one or more motion detection modules 508, and a user generated content classifier 509. The inference engine also includes a multimodal neural network module which takes the outputs of the unimodal modules and generates context information 511 in the UDS format.

### Audio Detection Modules

The one or more audio detection modules 502 may include one or more neural networks trained to classify audio data. Additionally, the one or more audio detection modules may include audio pre-processing stages and feature extraction stages. The audio preprocessing stage may be operable to condition the audio for classification by one or more neural networks.

Pre-processing may be optional because audio data is received directly from the unstructured data 501 and therefore would not need to be sampled and would ideally be free from noise. Nevertheless, the audio may be preprocessed to normalize signal amplitude and adjust for noise.

The feature extraction stage may generate audio features from the audio data to capture feature information from the audio. The feature extraction stage may apply transform filters to the pre-processed audio based on human auditory features such as for example and without limitation MeI Frequency cepstral coefficients (MFCCs) or based Spectral Feature of the audio for example short time Fourier transform. MFCC may provide a good filter selection for speech because human hearing is generally tuned for speech recognition additionally because many applications are designed for human use the audio may be configured for the human auditory system. Short Fourier Transform may provide more information about sounds outside the human auditory range and may be able to capture features of the audio lost with MFCC.

The extracted features are then passed to one or more of the audio classifiers. The one or more audio classifiers may be neural networks trained with a machine learning algorithm to classify events from the extracted features. The events may be game events such as gun shots, player death sounds, enemy death sounds, menu sounds, player movement sounds, enemy movement sounds, pause screen sounds, vehicle sounds, or voice sounds. In some implementations the audio detection module may speech recognition to convert speech into a machine-readable form and classify key words or sentences from the text. In some alternative implementations text generated by speech recognition may be passed to the text and character extraction module for further processing. According to some aspects of the present disclosure the classifier neural networks may be specialized to detect a single type of event from the audio. For example, and without limitation, there may be a classifier neural network trained to only classify features corresponding to weapon shot sounds and there may be another classifier neural network to recognize vehicle sounds. As such for each event type there may be a different specialized classifier neural network trained to classify the event from feature data. Alternatively, a single general classifier neural network may be trained to classify every event from feature data. Or in yet other alternative implementations a combination of specialized classifier neural network and generalized classifier neural networks may be used. In some implementations the classifier neural networks may be application specific and trained off a data set that includes labeled audio samples from the application. In other implementations the classifier neural network may be a universal audio classifier trained to recognize events from a data set that includes labeled common audio samples. Many applications have common audio samples that are shared or slightly manipulated and therefore may be detected by a universal audio classifier. In yet other implementations a combination of universal and application specific audio classifier neural networks may be used. In either case the audio classification neural networks may be trained de novo or alternatively may be further trained from pre-trained models using transfer learning. Pre-trained models for transfer learning may include without limitation VGGish, Sound net, Resnet, and Mobilenet. Note that for Resnet and Mobilenet the audio would be converted to spectrograms before classification.

In training the audio classifier neural networks, whether de novo or from a pre-trained module, the audio classifier neural networks may be provided with a dataset of game play audio. The dataset of gameplay audio used during training has known labels. The known labels of the data set are masked from the neural network at the time when the audio classifier neural network makes a prediction, and the labeled gameplay data set is used to train the audio classifier neural network with the machine learning algorithm after it has made a prediction as is discussed in the generalized neural network training section. In some implementations the universal neural network may also be trained with other datasets having known labels such as for example and without limitation real world sounds, movie sounds or YouTube video.

### Object Detection Modules

The one or more object detection modules 503 may include one or more neural networks trained to classify objects occurring within an image frame of video or an image frame of a still image. Additionally, the one or more object detection modules may include a frame extraction stage, an object localization stage, and an object tracking stage.

The frame extraction stage may simply take image frame data directly from the unstructured data. In some implementations the frame rate of video data may be down sampled to reduce the data load on the system. Additionally in some implementations the frame extraction stage may only extract key frames or I-frames if the video is compressed. In other implementations, only a subset of the available channels of the video may be analyzed. For example, it may be sufficient to analyze only the luminance (brightness) channel of the video but not the chrominance (color) channel. Access to the full unstructured data also allows frame extraction to discard or use certain rendering layers of video. For example, and without limitation, the frame extraction stage may extract the UI layer without other video layers for detection of UI objects or may extract non-UI rendering layers for object detection within a scene.

The object localization stage identifies features within the image. The object localization stage may use algorithms such as edge detection or regional proposal. Alternatively, the neural network may include deep learning layers that are trained to identify features within the image may be utilized.

The one or more object classification neural networks are trained to localize and classify objects from the identified features. The one or more classification neural networks may be part of a larger deep learning collection of networks within the object detection module. The classification neural networks may also include non-neural network components that perform traditional computer vision tasks such as template matching based on the features. The objects that the one or more classification neural networks are trained to localize and classify includes for example and without limitation, Game icons such as; player map indicator, map location indictor (Points of interest); item icons, status indicators, menu indicators, save indicators, and character buff indicators, UI elements such as health level, mana level, stamina level, rage level, quick inventory slot indicators, damage location indicators, UI compass indicators, lap time indicators, vehicle speed indicators, and hot bar command indicators, application elements such as weapons, shields, armors, enemies, vehicles, animals, trees, and other interactable elements.

According to some aspects of the present disclosure the one or more object classifier neural networks may be specialized to detect a single type of object from the features. For example, and without limitation, there may be object classifier neural network trained to only classify features corresponding to weapons and there may be another classifier neural network to recognize vehicles. As such for each object type there may be a different specialized classifier neural network trained to classify the object from feature data. Alternatively, a single general classifier neural network may be trained to classify every object from feature data. Or in yet other alternative implementations a combination of specialized classifier neural network and generalized classifier neural networks may be used. In some implementations the object classifier neural networks may be application specific and trained off a data set that includes label audio samples from the application. In other implementations the classifier neural network may be a universal object classifier trained to recognize objects from a data set that includes labeled frames containing common objects. Many applications have common objects that are shared or slightly manipulated and therefore may be detected by a universal object classifier. In yet other implementations a combination of universal and application specific object classifier neural networks may be used. In either case the object classification neural networks may be trained de novo or alternatively may be further trained from pre-trained models using transfer learning. Pre-trained models for transfer learning may include without limitation Faster R-CNN (Region-based convolutional neural network), YOLO (You only look once), SSD (Single shot detector), and Retinanet.

Frames from the application may be still images or may be part of a continuous video stream. If the frames are part of a continuous video stream the object tracking stage may be applied to subsequent frames to maintain consistency of the classification over time. The object tracking stage may apply known object tracking algorithms to associate a classified object in a first frame with an object in a second frame based on for example and without limitation the spatial temporal relation of the object in the second frame to the first and pixel values of the object in the first and second frame.

In training the object detection neural networks, whether de novo or from a pre-trained model, the object detection classifier neural networks may be provided with a dataset of game play video. The dataset of gameplay video used during training has known labels. The known labels of the data set are masked from the neural network at the time when the object classifier neural network makes a prediction, and the labeled gameplay data set is used to train the object classifier neural network with the machine learning algorithm after it has made a prediction as is discussed in the generalized neural network training section. In some implementations the universal neural network may also be trained with other datasets having known labels such as for example and without limitation real world images of objects, movies or YouTube video.

### Text and Character Extraction

Text and character extraction are similar tasks to object recognition but it is simpler and the scope is narrower. The text and character extraction module 504 may include a video preprocessing component, text detection component and text recognition component.

The video preprocessing component may modify the frames or portions of frames to improve recognition of text. For example, and without limitation, the frames may be modified by preprocessing de-blurring, de-noising and contrast enhancement.

Text detection components are applied to frames and operable to identify regions that contain text. Computer vision techniques such as edge detection and connected component analysis may be used by the text detection components. Alternatively, text detection may be performed by a deep learning neural network trained to identify regions containing text.

Low level Text recognition may be performed by optical character recognition. The recognized characters may be assembled into words and sentences. Higher level text recognition provides assembled words and sentences with context. A dictionary may be used to look up and tag contextually important words and sentences. Alternatively, a neural network may be trained with a machine learning algorithm to classify contextually important words and sentences. For example, and without limitation, the text recognition neural networks may be trained to recognize words for game weapons, armor, shields, trees, animals, vehicles, enemies, locations, landmarks, distances, times, dates, menu settings, items, questions, quests, and achievements. Similar to above, the text recognition neural network or dictionary may be universal and shared between applications or specialized for each application or a combination of the two.

In training the high-level text recognition neural networks may be trained de novo or using transfer learning from a pretrained neural network. Pretrained neural networks that may be used with transfer learning include for example and without limitation Generative Pretrained Transformer (GPT) 2, GPT 3, GPT 4, Universal Language Model Fine-Tuning (ULMFiT), Embeddings from Language Models (ELMo), Bidirectional Encoder Representations from Transformers (BERT) and similar. Whether de novo or from a pre-trained model, the high-level Text recognition neural networks may be provided with a dataset of gameplay text. The dataset of gameplay text used during training has known labels. The known labels of the data set are masked from the neural network at the time when the high-level text recognition neural network makes a prediction, and the labeled gameplay data set is used to train the high-level text recognition neural network with the machine learning algorithm after it has made a prediction as is discussed in the generalized neural network training section. In some implementations the universal neural network may also be trained with other datasets having known labels such as for example and without limitation real world images of text, books or websites.

### Image Classification

The Image classification module 505 classifies the entire image of the screen whereas object detection decomposes elements occurring within the image frame. The task of image classification is similar to object detection except it occurs over the entire image frame without an object localization stage and with a different training set. An image classification neural network may be trained to classify contextually important image information from an entire image. Contextually important information generated from the entire image may be for example, whether the image scene is day or night, whether the image is a game inventory screen, menu screen, character screen, map screen, statistics screen, etc. Some examples of pre-trained image recognition models that can be used for transfer learning include, but are not limited to, VGG, ResNet, EfficientNet, DenseNet, MobileNet, ViT, GoogLeNet, Inception, and the like.

The image classification neural networks may be trained de novo or trained using transfer learning from a pretrained neural network. Whether de novo or from a pre-trained module, the image classification neural networks may be provided with a dataset of gameplay image frames. The dataset of gameplay image frames used during training has known labels. The known labels of the data set are masked from the neural network at the time when the image classification neural network makes a prediction, and the labeled gameplay data set is used to train the image classification neural network with the machine learning algorithm after it has made a prediction as is discussed in the generalized neural network training section. In some implementations the universal neural network may also be trained with other datasets having known labels such as for example and without limitation images of the real world, videos of gameplay or game replays.

### Temporal Action Localization

Context information may include for example and without limitation, special moves, attacks, defense, and movements which are typically made up of a series of time localized movements within a series of image frames of a video. As such a temporal action localization module 506 may localize and classify movements occurring within the image frames of application data to generate movement context information.

The temporal action localization module may include a frame preprocessing component, feature extraction component, action proposal generation component, action classification component and Localization component.

The frame preprocessing component may take sequences of image frames as data directly from the unstructured data. Access to the full unstructured data also allows frame extraction to discard or use certain rendering layers of video. For example, frame preprocessing may extract non-UI rendering layers for object detection within a scene. Additionally, the preprocessing component may alter the image frames to improve detection for example and without limitation the frames may have their orientation and color normalized.

The feature extraction component may be a neural network component of the temporal localization module. The feature extraction component may have a series of convolutional layers and pooling neural network layers trained to extract low level and high-level features from video. The feature extraction component may be a pre-trained network, trained to extract low level and high-level features from image frames of a video without the need for further training. In some implementations, it may be desirable to train the feature extraction component from scratch.

The action proposal generation component breaks a sequence of image frames in the video into more processable space. In one implementation a sliding overlapping window may be used to extract features over each image frame in the sequence of images frame of the video data. In another implementation features may be taken from each image frame for a limited window of frames (i.e., a limited time period) in the video. Each window of frames may be overlapping in time as such this may be thought of as a sliding temporal window. In yet another implementation a non-overlapping window may be used.

The action classification component may include one or more neural networks trained to classify actions occurring within the window of extracted features provided by the action proposal component. The action classification component may include a different trained neural network for each of the different movements or movement types that are to be detected. The one or more action classification modules may be universal and shared between applications or may be specially trained for each application or a combination of both.

In training the action classification neural networks may be trained de novo or using transfer learning from a pretrained neural network. Whether de novo or from a pre-trained module, the action classification neural networks may be provided with a dataset containing a sequence of gameplay image frames. The dataset of gameplay image frames used during training has known labels of actions. The known labels of the data set are masked from the neural network at the time when the action classification neural network makes a prediction, and the labeled gameplay data set is used to train the action classification neural network with the machine learning algorithm after it has made a prediction as is discussed in the generalized neural network training section. The specialized neural network may have a data set including only videos or gameplay or game replays of the specific application, this may create a neural network that is good at predicting actions for a single application. In some implementations the universal neural network may also be trained with other datasets having known labels such as for example and without limitation videos of actions across many applications, actual game play of many applications or game replays of many applications.

After classification, the classification of the action is passed to the localization component which combines the classified action with the segments that were classified. The resulting combined information is then passed as a feature to the multi-modal neural networks.

### Input Detection

The unstructured dataset 501 may include inputs from peripheral devices. The input detection module 507 may take the inputs from the peripheral devices and identify the inputs. In some implementations the input detection module 507 may include a table containing commands for the application and output a label identifying the command when a matching input is detected. Alternatively, the input detection module may include one or more input classification neural networks trained to recognize commands from the peripheral inputs in the unstructured data. Some inputs are shared between applications for example and without limitation, many applications used a start button press for pausing the game and opening a menu screen and a select button press to open a different menu screen. Thus, according to some aspects of the present disclosure one or more of the input detection neural networks may be universal and shared between applications. In some implementations the one or more input classification neural networks may be specialized for each application and trained on a data set consisting of commands for the specific chosen application. In yet other implementations a combination of universal and specialized neural networks is used. Additionally in alternative implementations the input classification neural networks may be highly specific with a different trained neural network to identify each command for the context data. Context data may include commands that include for example and without limitation, pause commands, menu commands, movement commands, action commands, and selection commands.

The input classification neural networks may be provided with a dataset including peripheral inputs occurring during use of the computer system. The dataset of peripheral inputs used during training have known labels for commands. The known labels of the data set are masked from the neural network at the time when the input classification neural network makes a prediction, and the labeled data set of peripheral inputs is used to train the input classification neural network with the machine learning algorithm after it has made a prediction as is discussed in the generalized neural network training section. A specialized input classification neural network may have a data set that consists of recordings of inputs sequences that occur during operation of a specific application and no other applications; this may create a neural network that is good at predicting actions for a single application. In some implementations, a universal input classification neural network may also be trained with other datasets having known labels such as for example and without limitation input sequences across many different applications. In situations where available transfer learning models for processing peripheral inputs are limited or otherwise unsatisfactory, a “pre-trained” model may be developed that can process peripheral inputs for a particular game or other application. This pre-trained model may then be used for transfer learning for other games or applications.

### Motion Detection

Many applications also include a motion component in the unstructured data 501 set that may provide commands which could be included in context information. The motion detection module 508 may take the motion information from the unstructured data 501 and turn the motion data into commands for the context information. A simple approach to motion detection may include simply providing different thresholds and outputting a command each time an element from an inertial measurement unit exceeds the threshold. For example, and without limitation, the system may include a 2-gravity acceleration threshold in the X axis to output a command that the headset is changing direction. Another alternative approach is neural network-based motion classification. In this implementation the motion detection module may include the components of motion preprocessing, feature selection and motion classification.

The motion preprocessing component conditions the motion data to remove artifacts and noise from the data. The preprocessing may include noise floor normalization, mean selection, standard deviation evaluation, Root means square torque measurement, and spectral entropy signal differentiation.

The feature selection component takes preprocessed data and analyzes the data for features. Selecting features using techniques for example and without limitation principal component analysis, correlational analysis, sequential forward selection, backwards elimination and mutual information.

Finally, the selected features are applied to the motion classification neural networks trained with a machine learning algorithm to classify commands from motion information. In some implementations the selected features are applied to other machine learning models which do not include a neural network for example and without limitation, decision trees, random forests, and support vector machines. Some inputs are shared between applications for example and without limitation, many applications selection commands are simple commands to move a cursor. Thus, according to some aspects of the present disclosure one or more of the motion classification neural networks may be universal and shared between applications. In some implementations the one or more motion classification neural networks may be specialized for each application and trained on a data set consisting of commands for the specific chosen application. In yet other implementation a combination of universal and specialized neural networks is used. Additionally in alternative implementations the motion classification neural networks may be highly specific with a different trained neural network to identify each command for the context data.

The motion classification neural networks may be provided with a dataset including motion inputs occurring during use of the computer system. The dataset of motion inputs used during training has known labels for commands. The known labels of the data set are masked from the neural network at the time when the motion classification neural network makes a prediction, and the labeled data set of motion inputs is used to train the motion classification neural network with the machine learning algorithm after it has made a prediction as is discussed in the generalized neural network training section. A specialized motion classification neural network may have a data set that consists of recordings of inputs sequences that occur during operation of a specific application and no other application; this may create a neural network that is good at predicting actions for a single application. In some implementations a universal motion classification neural network may also be trained with other datasets having known labels such as for example and without limitation input sequences across many different applications.

### User Generated Content Classification

The system may also be operable to classify elements occurring within user generated content. As used herein user generated content may be data generated by the user on the system coincident with use of the application. For example, and without limitation, user generated content may include chat content, blog posts, social media posts, screen shots, user generated documents. The User Generated Content Classification module 509 may include component from other modules such as the text and character extraction module and the object detection module to place the user generated content in a form that may be used as context data. For example, and without limitation, the User Generated Content Classification may decompose text and character extraction components to identify contextually important statements made by the user in a chat room. As a specific, non-limiting example the user may make a statement in chat such as ‘pause’ or ‘bio break’ which may be detected and used as meta data indicating the user is paused, on a break or do not disturb. As another example, the User Generated Content Classification module 509 may identify moments the user chooses to grab a screenshot. Such moments are likely to be of significance to the user. Screen shots of such moments may be analyzed and classified with labels, e.g., “winning a trophy” or “setting a game record” and the labels may be used as a metadata.

### Multi-Modal Networks

The multi-modal networks 510 fuse the information generated by the modules 502-509 and generates structured game context information 511 from the separate modal networks of the modules. In some implementations the data from the separate modules are concatenated together to form a single multi-modal vector. The multi-modal vector may also include unprocessed data from unstructured data.

The multi-modal neural networks 510 may be trained with a machine learning algorithm to take the multi-modal vector and generate structured Game context information 511 in the form of UDS data. Training the multi-modal neural networks 510 may include end to end training of all of the modules with a data set that includes labels for multiple modalities of the input data. During training the labels of the multiple input modalities are masked from the multi-modal neural networks before prediction. The labeled data set of multi-modal inputs is used to train the multi-modal neural networks with the machine learning algorithm after it has made a prediction as is discussed in the generalized neural network training section.

The multi-modal neural networks 510 may include a neural network trained with a machine learning algorithm to determine one or more irrelevant modules from the structured application state data. During training the Context State update module may be trained with training data that has labels that are masked during training. The labeled training data may include structured application data that is labeled with one or more irrelevant modules. Context state update neural network module predicts one or more modules that are irrelevant modules with the masked training data and then trained with the labeled training data. For further discussion on training see the general neural network training section above.

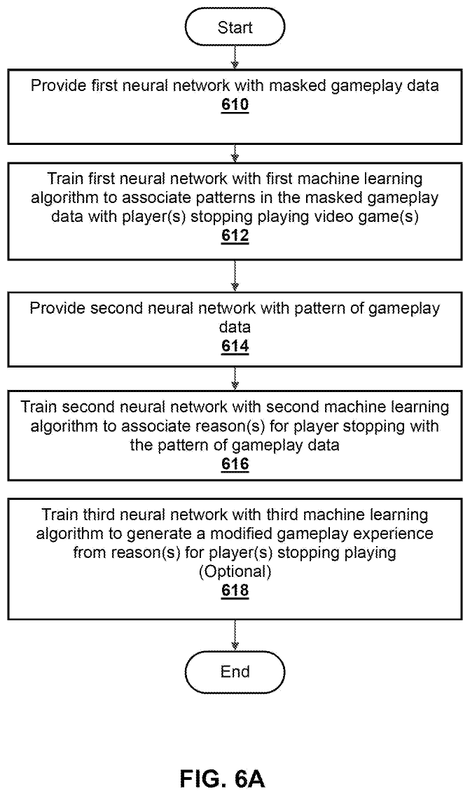

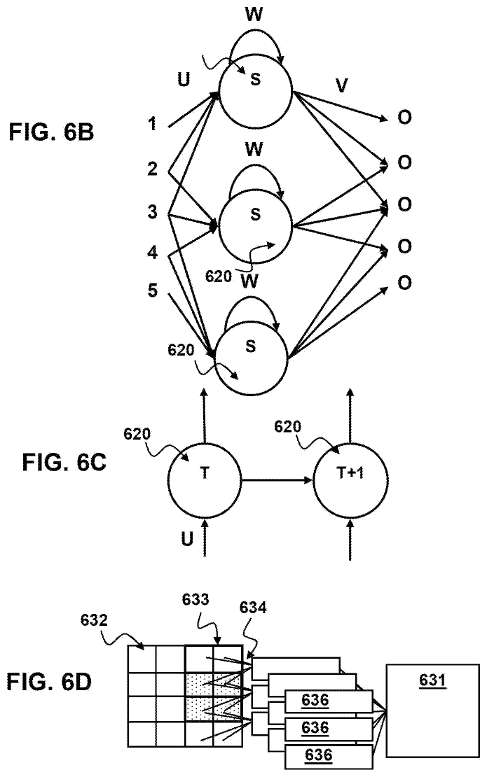

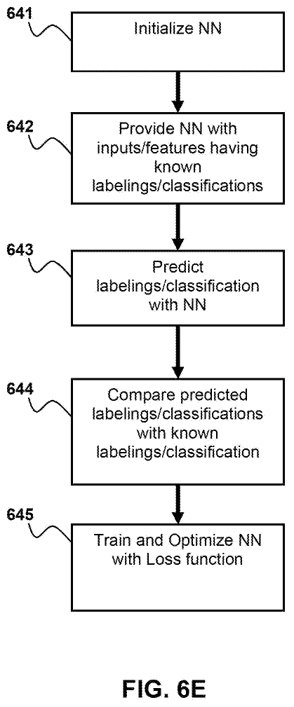

According to aspects of the present disclosure, the pattern recognition module 120, inference module 130 and feedback module 140 may include trained neural networks. Aspects of the present disclosure include methods of training such neural networks. By way of example, and not by way of limitation, FIG. 6A depicts a flowchart that illustrates a method for training a churn detection system for video games, according to some aspects of the present disclosure. In some implementations, at 610, the method may include providing masked gameplay data for a video game to a first neural network, such as one or more of the pattern recognition neural networks 122 in the pattern recognition module 120. In some implementations, the masked gameplay data may include one or more modes of multimodal gameplay data. In some implementations, the masked gameplay data may be provided in the form of one or more feature vectors to reduce the dimensionality of the data while retaining the relevant information. As indicated at 620, the first neural network may be trained with a first machine learning, e.g., algorithm 124, to associate one or more patterns in the masked gameplay data with a player stopping playing the video game using labeled gameplay data, which may include one or more modes of multimodal data or may include one or more feature vectors. At 630, the method may include providing a second neural network, such as an inferencing neural network 132 of the inferencing module 130 with a pattern of gameplay data for a video game. In some implementations, the gameplay data may be provided in the form of one or more feature vectors to reduce the dimensionality of the data while retaining the relevant information. The second neural network is then trained with a second machine learning model, e.g., algorithm 134, to associate a reason for a player to stop playing a video game with the pattern of gameplay, as indicated at 640. As noted above, the second machine learning algorithm may be trained with unlabeled data, e.g., in the case of an unsupervised learning models. Alternatively, the machine learning model may be trained using labeled patterns of gameplay data.

In some implementations, the method 600 may optionally include training a third neural network 142 with a third machine learning algorithm 144 to generate a modified gameplay experience from reason(s) for player(s) stopping playing, as indicated at 650. Historical gameplay data may be collected and cleaned for use in the third neural network 142. For example, gameplay data may include raw data such as player interactions, playtime, behavioral patterns, achievements, frequency of play. Some of this data might need to be normalized or standardized to make it suitable for use in a neural network. If the data is labeled, cleaning the data may also involve separating the dataset into a training set and a test set. The labels in the dataset will help the third machine learning algorithm 144 to optimize the network weights to generate the gameplay parameters to minimize the reasons for the players to stop playing.

By way of example, and not by way of limitation, the third neural network may be a classification type neural network. The inputs to such a network may include features such as player playing styles, metadata of the game and the particular game activities players are struggling with. Labels may be players' churns on different game experiences (e.g., different levels of difficulty). A machine learning algorithm 144 may train the third neural network to learn conditional probabilities of a particular player churning with a given game experience, which will then be used to recommend a game experience, e.g., by stack ranking the conditional probabilities across all potential game experiences. This exercise may be done for each player churn reason, to produce a churn reason specific model.

Although the aspects of the disclosure are not so limited, many of the implementations discussed above utilize trained neural networks trained by corresponding machine learning algorithms. Aspects of the present disclosure include methods of training such neural networks with such machine learning algorithms. By way of example, and not limitation, there are a number of ways that the machine learning algorithms 124, 134 may train the corresponding neural networks 122, 132. Some of these are discussed in the following section.

### Generalized Neural Network Training

The NNs discussed above may include one or more of several different types of neural networks and may have many different layers. By way of example and not by way of limitation the neural network may consist of one or multiple convolutional neural networks (CNN), recurrent neural networks (RNN) and/or dynamic neural networks (DNN). The Motion Decision Neural Network may be trained using the general training method disclosed herein.

By way of example, and not limitation, FIG. 6A depicts the basic form of an RNN that may be used, e.g., in the trained model. In the illustrated example, the RNN has a layer of nodes 620, each of which is characterized by an activation function S, one input weight U, a recurrent hidden node transition weight W, and an output transition weight V. The activation function S may be any non-linear function known in the art and is not limited to the (hyperbolic tangent (tanh) function. For example, the activation function S may be a Sigmoid or ReLu function. Unlike other types of neural networks, RNNs have one set of activation functions and weights for the entire layer. As shown in FIG. 6B, the RNN may be considered as a series of nodes 620 having the same activation function moving through time T and T+1. Thus, the RNN maintains historical information by feeding the result from a previous time T to a current time T+1.

In some implementations, a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time as described by Hochreiter & Schmidhuber “Long Short-term memory” Neural Computation 9(8):1735-1780 (1997), which is incorporated herein by reference.

FIG. 6C depicts an example layout of a convolution neural network such as a CRNN, which may be used, e.g., in the trained model according to aspects of the present disclosure. In this depiction, the convolution neural network is generated for an input 632 with a size of 4 units in height and 4 units in width giving a total area of 16 units. The depicted convolutional neural network has a filter 633 size of 2 units in height and 2 units in width with a skip value of 1 and a channel 636 of size 9. For clarity in FIG. 6C only the connections 634 between the first column of channels and their filter windows is depicted. Aspects of the present disclosure, however, are not limited to such implementations. According to aspects of the present disclosure, the convolutional neural network may have any number of additional neural network node layers 631 and may include such layer types as additional convolutional layers, fully connected layers, pooling layers, max pooling layers, local contrast normalization layers, etc. of any size.

As seen in FIG. 6D Training a neural network (NN) begins with initialization of the weights of the NN at 1541. In general, the initial weights should be distributed randomly. For example, an NN with a tanh activation function should have random values distributed between

$$- \frac{1}{\sqrt{n}} and \frac{1}{\sqrt{n}}$$

where n is the number of inputs to the node.

After initialization, the activation function and optimizer are defined. The NN is then provided with a feature vector or input dataset at 642. Each of the different feature's vectors that are generated with a unimodal NN may be provided with inputs that have known labels. Similarly, the multimodal NN may be provided with feature vectors that correspond to inputs having known labeling or classification. The NN then predicts a label or classification for the feature or input at 643. The predicted label or class is compared to the known label or class (also known as ground truth) and a loss function measures the total error between the predictions and ground truth over all the training samples at 644. By way of example and not by way of limitation the loss function may be a cross entropy loss function, quadratic cost, triplet contrastive function, exponential cost, etc. Multiple different loss functions may be used depending on the purpose. By way of example and not by way of limitation, for training classifiers a cross entropy loss function may be used whereas for learning pre-trained embedding a triplet contrastive function may be employed. The NN is then optimized and trained, using the result of the loss function and using known methods of training for neural networks such as backpropagation with adaptive gradient descent etc., as indicated at 645. In each training epoch, the optimizer tries to choose the model parameters (i.e., weights) that minimize the training loss function (i.e., total error). Data is partitioned into training, validation, and test samples.

During training, the Optimizer minimizes the loss function on the training samples. After each training epoch, the model is evaluated on the validation sample by computing the validation loss and accuracy. If there is no significant change, training can be stopped, and the resulting trained model may be used to predict the labels of the test data.

Thus, the neural network may be trained from inputs having known labels or classifications to identify and classify those inputs. Similarly, a NN may be trained using the described method to generate a feature vector from inputs having a known label or classification. While the above discussion is relation to RNNs and CRNNS the discussions may be applied to NNs that do not include Recurrent or hidden layers.

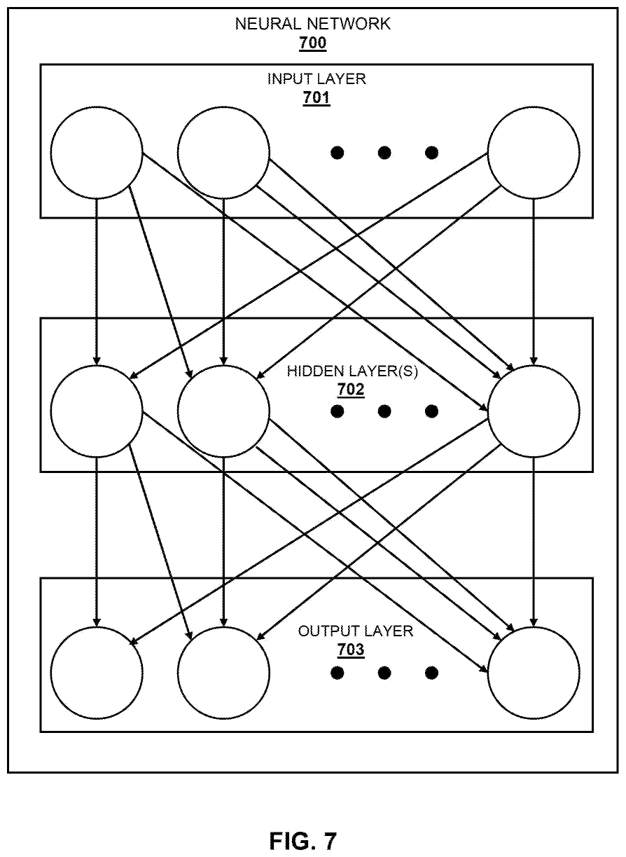

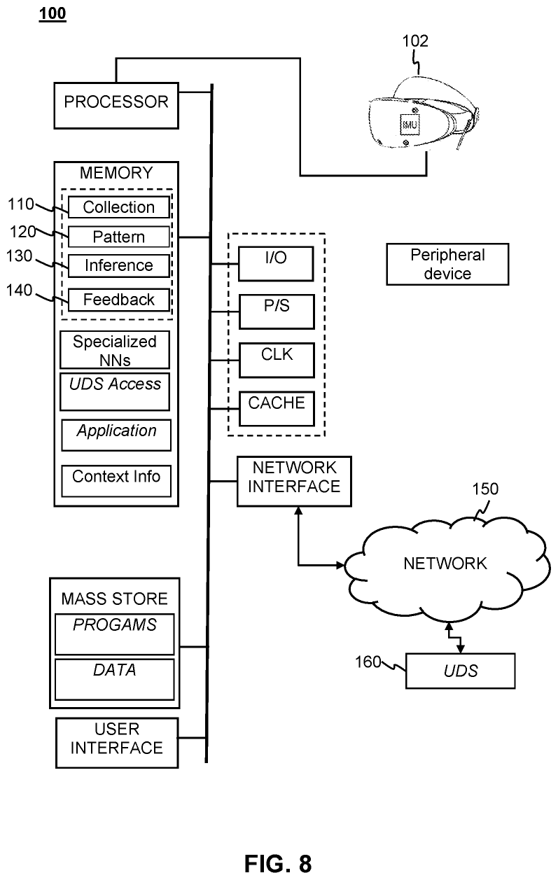

FIG. 7 illustrates a deep learning neural network 700 operable to analyze gameplay data to identify a pattern associated with one or more patterns associated with a player stopping playing the video game, and/or to associate the one or more identified patterns with one or more reasons for the player stopping playing the video game, in accordance with an aspect of the present disclosure. Specifically, the neural network 700 may be one of the pattern recognition neural networks 122 of the pattern recognition module 120. In such an implementation the neural network 700 may be operable to receive input information related to game plays of one or more players playing a gaming application that has been collected by the collecting module 110 and to identify one or more patterns associated with a player stopping playing the video game. Alternatively, the neural network 700 may be one of the inference neural networks 132 of the inference module 130. In such an implementation the neural network 700 may be operable to receive pattern information related to one or more patterns identified by the pattern recognition module 120 and to associate the patterns with one or more reasons for the player stopping playing the video game generated game.

The deep learning neural network 700 may utilize artificial intelligence, including deep learning algorithms (e.g., pattern recognition algorithms 124), reinforcement learning, or other artificial intelligence-based algorithms to build event models for players stopping playing the game, event of dramatic significance models, reason template models, etc. For example, during a learning and/or modeling phase, input data is used by the deep learning neural network 700 to create event models that can be used to associate identified patterns of gameplay data with reasons for players stopping playing a game.

In particular, neural network 700 represents an example of an automated analysis tool for analyzing data sets to determine the events performed during a gaming application, such as events of significance to a player stopping playing the game, or events occurring during the normal game play of an application. Different types of neural networks 700 are possible. By way of example, the neural network 700 may support deep learning. Accordingly, a deep neural network, a convolutional deep neural network, and/or a recurrent neural network using supervised or unsupervised training can be implemented. In another example, the neural network 700 may include a deep learning network that supports reinforcement learning. For instance, the neural network 700 is set up as a Markov decision process (MDP) that supports a reinforcement learning algorithm.

Generally, the neural network 700 represents a network of interconnected nodes, such as an artificial neural network. Each node learns some information from data. Knowledge can be exchanged between the nodes through the interconnections. Input to the neural network 700 activates a set of nodes. In turn, this set of nodes activates other nodes, thereby propagating knowledge about the input. This activation process is repeated across other nodes until an output is provided.

As illustrated, the neural network 700 includes a hierarchy of nodes. At the lowest hierarchy level, an input layer 701 exists. The input layer 701 includes a set of input nodes. For example, each of these input nodes is mapped to local data representative of events occurring during game plays of a gaming application. For example, the data may be collected from live game plays, or automated game plays performed through simulation.

At the highest hierarchical level, an output layer 703 exists. The output layer 703 includes a set of output nodes. An output node represents a decision (e.g., prediction) that relates to information of an event. As such, the output nodes may match an event occurring within a game play of a gaming application given a corresponding context to a particular modeled event.

These results can be compared to predetermined and true results obtained from previous game play sessions in order to refine and/or modify the parameters used by the deep learning neural network 700 to iteratively determine the appropriate gameplay pattern or patterns corresponding to a player stopping playing and/or determine the reason or reasons for a player stopping playing. That is, the nodes in the neural network 700 learn the parameters of the models that can be used to make such decisions when refining the parameters. In that manner, a given pattern may be associated with ever refined modeled reasons for stopping, and possibly to a new pattern or reason for stopping.

In particular, a hidden layer 702 exists between the input layer 701 and the output layer 703. The layer 702 includes “N” number of hidden layers, where “N” is an integer greater than or equal to one. In turn, each of the hidden layers also includes a set of hidden nodes. The input nodes are interconnected to the hidden nodes. Likewise, the hidden nodes are interconnected to the output nodes, such that the input nodes are not directly interconnected to the output nodes. If multiple hidden layers exist, the input nodes are interconnected to the hidden nodes of the lowest hidden layer. In turn, these hidden nodes are interconnected to the hidden nodes of the next hidden layer, and so on and so forth. The hidden nodes of the next highest hidden layer are interconnected to the output nodes. An interconnection connects two nodes. The interconnection has a numerical weight that can be learned, rendering the neural network adaptive to inputs and capable of learning.

Generally, the hidden layer 702 allows knowledge about the input nodes to be shared among all the tasks corresponding to the output nodes. To do so, a transformation f is applied to the input nodes through the hidden layer 702, in one implementation. In an example, the transformation f is non-linear. Different non-linear transformations f is available including, for instance, a linear rectifier function f(x)=max(0,x).

The neural network 700 also uses a cost function c to find an optimal solution. The cost function measures the deviation between the prediction that is output by the neural network 700 defined as f(x), for a given input x and the ground truth or target value y (e.g., the expected result). The optimal solution represents a situation where no solution has a cost lower than the cost of the optimal solution. An example of a cost function is the mean squared error between the prediction and the ground truth, for data where such ground truth labels are available. During the learning process, the neural network 700 can use back-propagation algorithms to employ different optimization methods to learn model parameters (e.g., the weights for the interconnections between nodes in the hidden layers 702) that minimize the cost function. An example of such an optimization method is stochastic gradient descent.

By way of example and not by way of limitation, the training dataset for the neural network 700 can be from a same data domain. For instance, the neural network 700 is trained for learning the patterns and/or characteristics of similar queries based on a given set of inputs or input data. For example, the data domain includes queries related to a specific scene in a gaming application for a given gaming context. In another example, the training dataset is from different data domains to include input data other than a baseline. As such, the neural network 700 may recognize a query using other data domains, or may be operable to generate a response model for a given query based on those data domains.

While specific embodiments have been provided to demonstrate leveraging of artificial intelligence to generate commentary that can enhance a video game trophy in original and creative ways, these are described by way of example and not by way of limitation. Those skilled in the art having read the present disclosure will realize additional embodiments falling within the spirit and scope of the present disclosure.

It should be noted, that access services, such as player chum detection for video games of the present disclosure, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

Aspects of the present disclosure may be practiced with various computer system configurations including hand-held devices, microprocessor systems, microprocessor-based or programmable consumer electronics, minicomputers, mainframe computers and the like. The disclosure can also be practiced in distributed computing environments where tasks are performed by remote processing devices that are linked through a wire-based or wireless network.

It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

It should be understood that the various implementations described herein may be executed on any type of client device. In some embodiments, the client device is a head mounted display (HMD), or projection system.

While specific embodiments have been provided to demonstrate the enhancement of trophies associated with game play of a gaming application, and/or for packaging commentary data with trophy data to provide an enhanced trophy that is compelling to its viewers, these are described by way of example and not by way of limitation. Those skilled in the art having read the present disclosure will realize additional embodiments falling within the spirit and scope of the present disclosure.

It should be understood that the various embodiments and implementations described herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Aspects of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

With the above implementations and embodiments in mind, it should be understood that aspects of the present disclosure can employ various computer-implemented operations involving data stored in computer systems. These operations are those requiring physical manipulation of physical quantities. Any of the operations described herein that form part of embodiments of the present disclosure are useful machine operations. Aspects of the present disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The disclosure can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing disclosure has been described in some detail for purposes of clarity of understanding, it will be apparent that certain changes and modifications can be practiced within the scope of the appended claims. Accordingly, the present embodiments are to be considered as illustrative and not restrictive, and embodiments of the present disclosure is not to be limited to the details given herein, but may be modified within the scope and equivalents of the appended claims.

What is claimed is:

1. A system for detecting churn in video games, comprising:
a data collection module operable to collect gameplay data for a video game;
a pattern recognition module operable to analyze the collected gameplay data to identify one or more patterns associated with a player stopping playing the video game;
an inference module operable to associate the one or more identified patterns with one or more reasons for the player stopping playing the video game; and
a feedback module operable to present a game developer with the one or more reasons for the player stopping playing the video game.

2. The system of claim 1 wherein the pattern recognition module includes one or more neural networks trained to detect patterns in gameplay data that are associated with player difficulty with video games.

3. The system of claim 2 wherein the inference module includes one or more neural networks trained to classify a difficulty with the video game from the identified one or more patterns.

4. The system of claim 2 wherein the inference module includes one or more neural networks operable to identify a game world location from patterns of gameplay data.

5. The system of claim 4 wherein the inference module includes one or more neural networks trained to classify a difficulty with the video game from the identified game world location.

6. The system of claim 4 wherein the inference module includes one or more neural networks trained to classify a difficulty with the video game from the identified one or more pattern and identified game world location.

7. The system of claim 1, wherein the data collection module is operable to collect the gameplay data over a network from a plurality of video game devices.

8. The system of claim 1, wherein the data collection module is operable to collect player chat data.

9. The system of claim 8, wherein the pattern recognition module includes one or more neural networks trained to detect patterns in player chat data that are associated with player difficulty with one or more video games.

10. The system of claim 8, wherein the pattern recognition module includes one or more neural networks trained to detect patterns in player chat data that are associated with player difficulty with another player of one or more video games.

11. The system of claim 1, wherein the data collection module is operable to collect controller input data for one or more video game peripheral devices.

12. The system of claim 11, wherein the data collection module is operable to collect peripheral input data for one or more video game controllers and the pattern recognition module is operable to identify one or more patterns in the peripheral input data associated with a player stopping playing the video game.

13. The system of claim 12, wherein the peripheral input data includes for inputs to one or more video game controllers.

14. The system of claim 12, wherein the peripheral input data includes inertial measurement unit (IMU) data for one or more IMU associated with one or more video game controllers.

15. The system of claim 12, wherein the peripheral input data includes for inputs to one or more microphones.

16. The system of claim 1, wherein the feedback module is further operable to analyze the one or more reasons for the player stopping playing the video game and to generate a different gameplay experience for the video game and present the different gameplay experience to a subset of players of the video game.

17. The system of claim 16, wherein the feedback module is operable to determine a difference in player retention between players that were presented with the different gameplay experience and players that were not presented the different gameplay experience.

18. A method for detecting churn in video games, comprising:
collecting gameplay data for a video game;
analyzing the gameplay data with a first trained neural network to identify a pattern associated with one or more patterns associated with a player stopping playing the video game;
analyzing the one or more patterns with a second trained neural network to associate the one or more identified patterns with one or more reasons for the player stopping playing the video game; and
presenting a game developer with the one or more reasons for the player stopping playing the video game.

19. A method for training a churn detection system for video games, comprising:
providing a first neural network with masked gameplay data for a video game;
training the first neural network with a first machine learning algorithm to associate one or more patterns in the masked gameplay data with a player stopping playing the video game using labeled gameplay data;
providing second neural network with a pattern of gameplay data for a video game; and
training the second neural network with a second machine learning algorithm to associate one or more reasons for the player stopping playing the video game with the pattern of gameplay data.

20. The method of claim 19, further comprising training a third neural network with a third machine learning algorithm to generate a modified gameplay experience for the video game from the one or more reasons for the player stopping playing the video game.
